(19) United States
(12) Patent Application Publication
(10) Pub. No.: US 2025/0252312 A1
(43) Pub. Date: Aug. 7, 2025

(54) Performing Inference And Training Using Sparse Neural Network

(71) Applicant: Numenta, Inc., Redwood City, CA (US)

(72) Inventors: Subutai Ahmad, Palo Alto, CA (US); Luiz Scheinkman, Sunnyvale, CA (US)

(21) Appl. No.: 19/060,653

(22) Filed: Feb. 22, 2025

Related U.S. Application Data
(63) Continuation of application No. 18/312,011, filed on May 4, 2023, now Pat. No. 12,260,337.
Application No. 18/312,011 is a continuation of application No. 16/696,991, filed on Nov. 26, 2019, now Pat. No. 11,681,922.

(51) Int. Cl. G06N 3/084; G06N 3/04

(52) U.S. Cl. CPC G06N 3/084; G06N 3/04

(57) ABSTRACT

An inference system trains and performs inference using a sparse neural network. The sparse neural network may include one or more layers, and each layer may be associated with a set of sparse weights that represent sparse connections between nodes of a layer and nodes of a previous layer. A layer output may be generated by applying the set of sparse weights associated with the layer to the layer output of a previous layer. Moreover, the one or more layers of the sparse neural network may generate sparse layer outputs. By using sparse representations of weights and layer outputs, robustness and stability of the neural network can be significantly improved, while maintaining competitive accuracy.

### CROSS-REFERENCE TO RELATED APPLICATIONS

This is a continuation of U.S. patent application Ser. No. 18/312,011, filed on May 4, 2023, which is a continuation of U.S. patent application Ser. No. 16/696,991, filed on Nov. 26, 2019 (issued as U.S. Pat. No. 11,681,992), which are incorporated by reference herein in their entirety.

### BACKGROUND

### 1. Field of the Disclosure

The present disclosure relates to a neural network for processing input data, and more specifically to a sparse neural network for performing inference and training on input data.

### 2. Description of the Related Arts

Machine-learned neural networks can be used to perform a wide variety of tasks, including inference and prediction, on input data. For example, a neural network can be used to perform object detection on whether content items such as images or videos contain objects-of-interest. As another example, a neural network can be used to predict likelihoods that users will interact with a content item, or predict the next one or more word tokens given previous word tokens in an electronic document.

A neural network may generally include a set of layers, each including one or more nodes. A layer output at nodes of a given layer is generated by applying a transformation to the layer output at nodes of a previous layer. Specifically, during the inference process, the layer output of the given layer is generated by applying a set of weights associated with the layer to the layer output of the previous layer. The set of weights represents connections between nodes of the given layer and nodes at the previous layer, and are updated through a training process. The inference data can be generated by propagating the input data through the layers of the neural network.

### SUMMARY

Embodiments relate to performing inference using a neural network where sparsity of weights for producing a layer output in a current layer is equal to or above a threshold. The neural network may include at least the current layer that generates an intermediate output for nodes of the current layer by applying the set of weights to a layer output of a previous layer that is based on input data. The layer outputs for nodes of the current layer are generated by processing the intermediate outputs. Specifically, the layer outputs may be generated by selecting intermediate outputs for a subset of nodes of the current layer, and may have a sparsity equal to or greater than a second threshold.

### BRIEF DESCRIPTION OF THE DRA WINGS

The teachings of the embodiments of the present invention can be readily understood by considering the following detailed description in conjunction with the accompanying drawings.

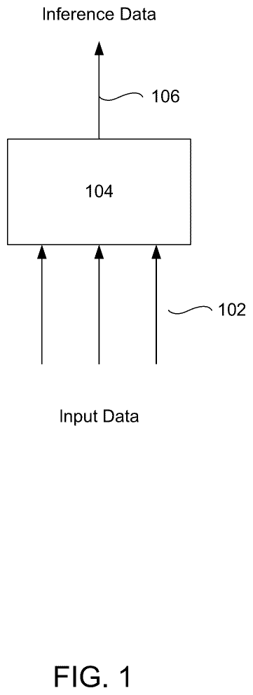

FIG. 1 is a conceptual diagram of an inference system 104, according to one embodiment.

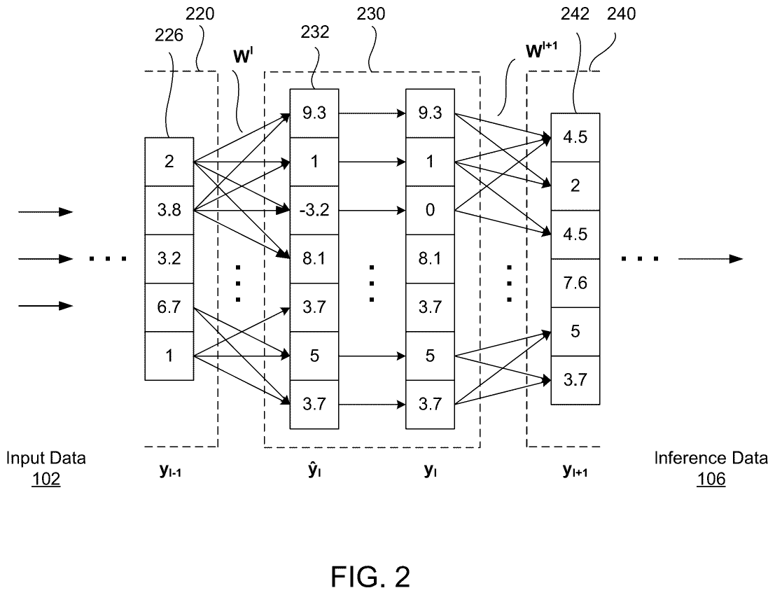

FIG. 2 illustrates an example process for performing inference using a neural network, according to an embodiment.

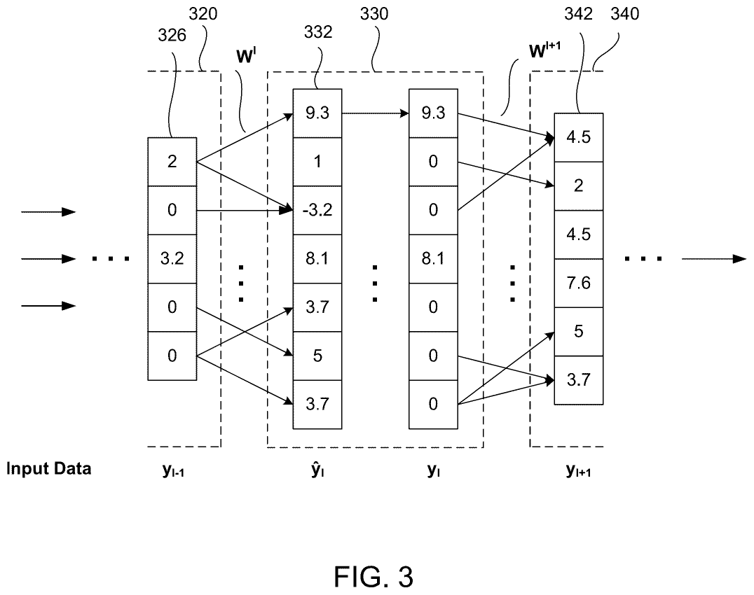

FIG. 3 illustrates an example process for performing inference using a sparse neural network, according to an embodiment.

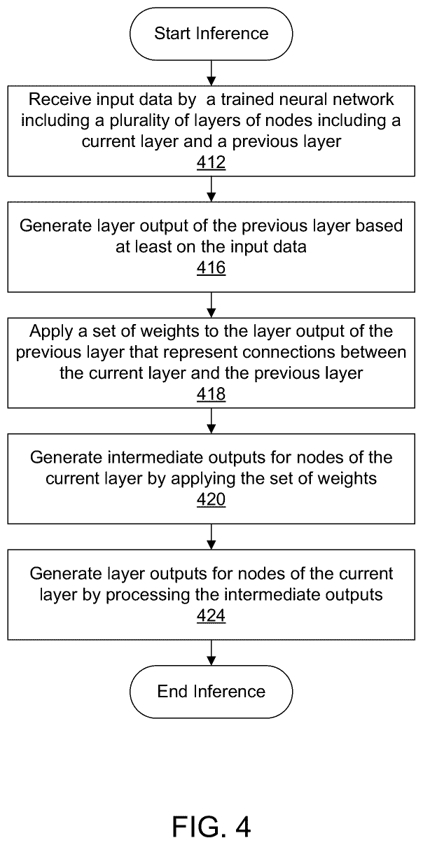

FIG. 4 is a flowchart illustrating a method of performing inference using a sparse neural network, according to one embodiment.

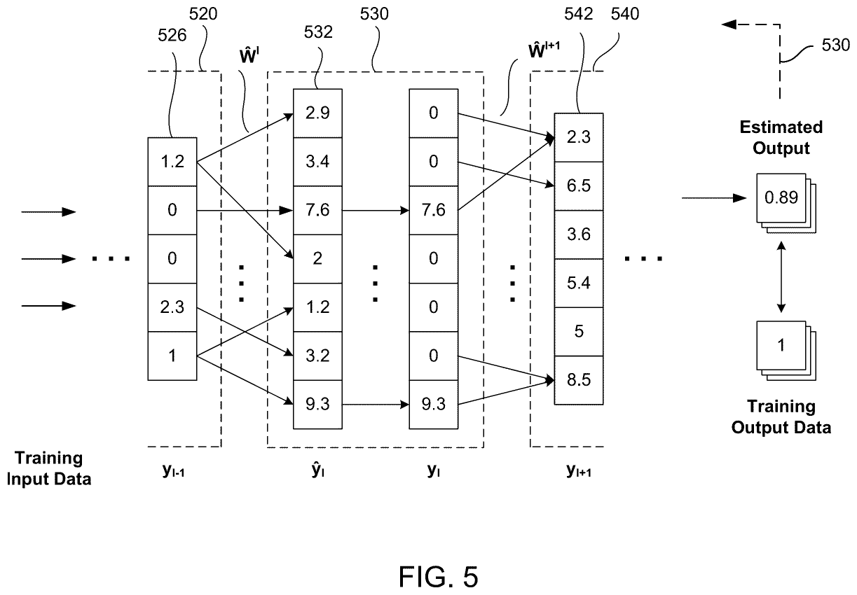

FIG. 5 illustrates an example process for training a sparse neural network, according to an embodiment.

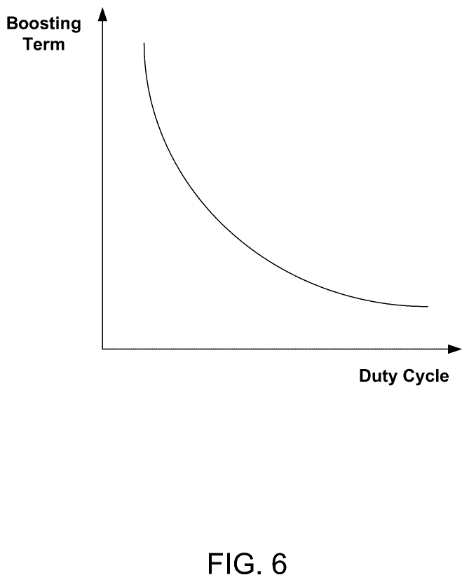

FIG. 6 illustrates an example exponential relationship between the boosting term and the duty cycle for a node, according to an embodiment.

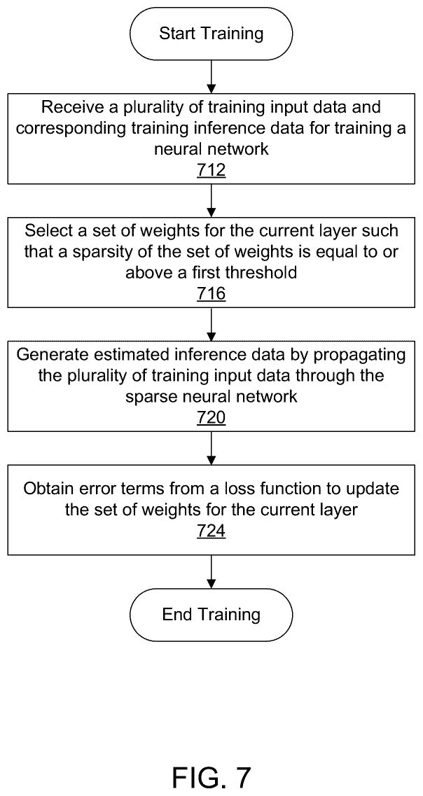

FIG. 7 is a flowchart illustrating a method of training a sparse neural network, according to one embodiment.

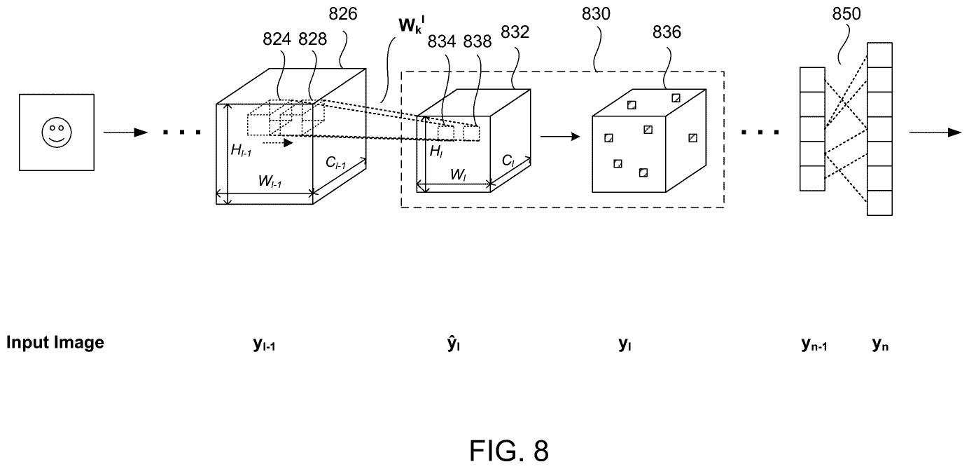

FIG. 8 illustrates a sparse convolutional neural network (CNN) architecture, according to an embodiment.

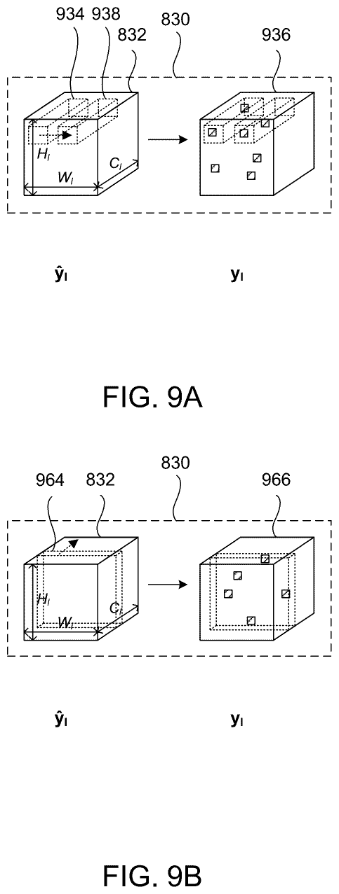

FIGS. 9A and 9B illustrate generating sparse tensors in a convolutional layer, according to an embodiment.

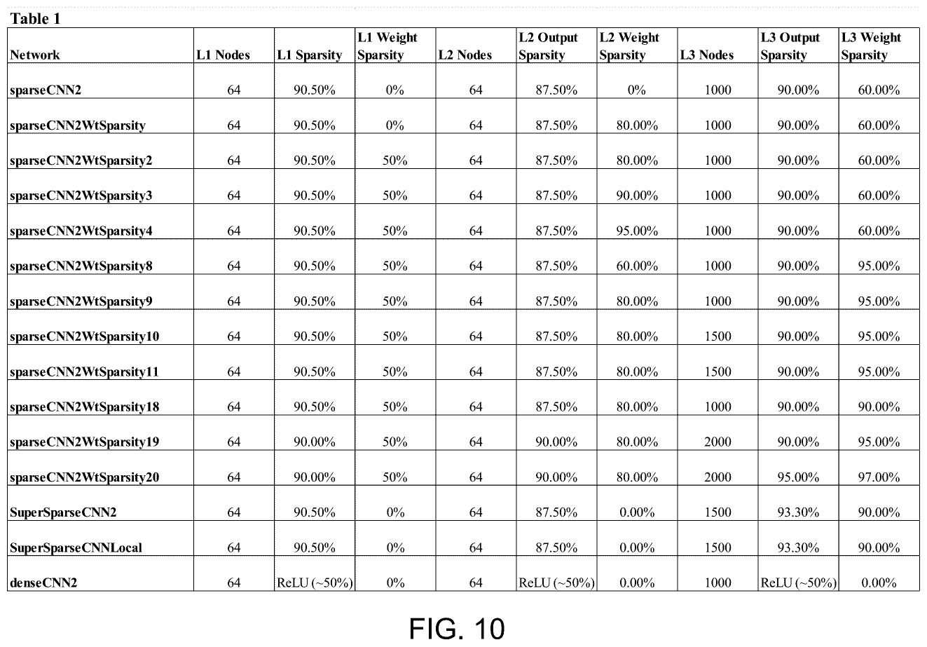

FIG. 10 illustrates sparsity characteristics for weights and layer outputs of a set of example neural networks.

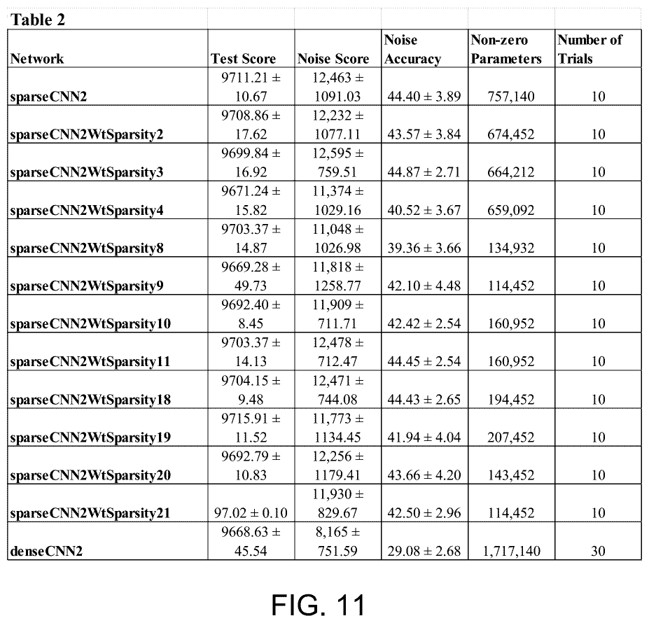

FIG. 11 illustrates experimental performance metrics of the example neural networks.

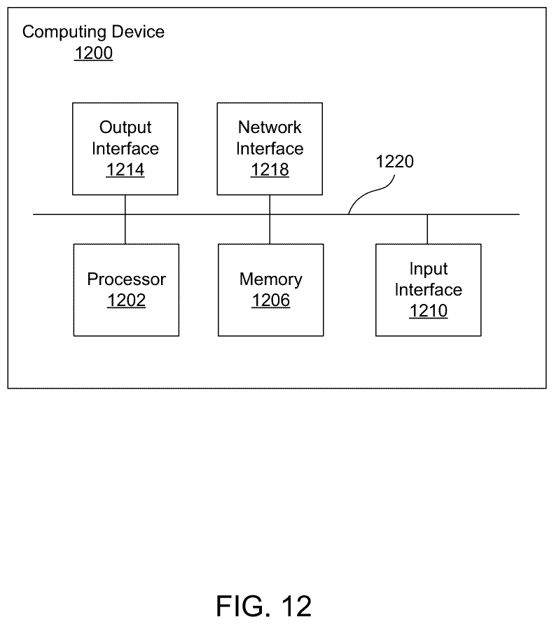

FIG. 12 is a block diagram of a computing device for implementing inference systems according to embodiments.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure set forth herein is intended to be illustrative, but not limiting, of the scope, which is set forth in the claims.

Embodiments relate to an inference system for training and performing inference using a sparse neural network. The sparse neural network may include one or more layers, and each layer may be associated with a set of sparse weights that represent sparse connections between nodes of a layer and nodes of a previous layer. A layer output may be generated by applying the set of sparse weights associated with the layer to the layer output of a previous layer. Moreover, the one or more layers of the sparse neural network may generate sparse layer outputs. By using sparse representations of weights and layer outputs, robustness and stability of the neural network can be significantly improved, while maintaining competitive accuracy. In addition, sparse neural networks can be more efficient to process computationally, since many operations, such as multiplication, can be skipped due to the high number of zero values in the neural network.

### High-Level Overview of Inference System

FIG. 1 is a conceptual diagram of an inference system 104, according to one embodiment. The inference system 104 performs inference and predictions on input data 102. In one particular embodiment referred throughout the remainder of the specification, the inference system 104 performs inference on input data 102, and generates inference data 106. For example, the inference system 104 may receive input data 102 corresponding to images of a road, and perform object recognition for pedestrians based on the received inputs. The inference data 106 may indicate locations of pedestrians in the image. As another example, the inference system 104 may receive input data 102 corresponding to input text in an electronic document, and the inference data 106 may indicate predictions for the next word tokens that are likely to come after the input text.

The input data 102 may include, among others, images, videos, audio signals, sensor signals (e.g., tactile sensor signals), data related to network traffic, financial transaction data, communication signals (e.g., emails, text messages, and instant messages), documents, insurance records, biometric information, parameters for manufacturing process (e.g., semiconductor fabrication parameters), inventory patterns, energy or power usage patterns, data representing genes, results of scientific experiments or parameters associated with operation of a machine (e.g., vehicle operation) and medical treatment data. The underlaying representation (e.g., photo, audio, etc.) can be stored in a non-transitory storage medium. In one embodiment, the input data 102 is encoded into a vector signal and fed to the inference system 104.

The inference system 104 may process the input data 102 to produce the inference data 106 representing, among others, identification of objects, identification of recognized gestures, classification of digital images as pornographic or non-pornographic, identification of email messages as unsolicited bulk email (“spam”) or legitimate email (“non-spam”), identification of a speaker in an audio recording, classification of loan applicants as good or bad credit risks, identification of network traffic as malicious or benign, identify of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, identification of anomalous patterns in insurance records, prediction on results of experiments, indication of an illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, and a summary of text or prediction on reaction to medical treatments.

The inference system 104 performs inference using a neural network that includes a set of layers of nodes, in which a layer output at nodes of a current layer are a transformation of the layer outputs at previous layers. Specifically, the layer output at nodes of the current layer may be generated by applying a set of weights to the layer output of the previous layers. The set of weights represent connections between nodes of the current layer and nodes at the previous layers, and are learned through a training process. The inference data 106 is generated by propagating the input data 102 through the layers of the neural network.

In one embodiment, the inference system 104 performs inference using a sparse neural network. The sparse neural network includes one or more layers associated with a set of sparse weights, in which a sparsity of the set of weights is equal to or above a first threshold. Moreover, the sparse neural network may include one or more layers that generate sparse layer outputs where a sparsity of the layer output is equal to or above a second threshold. As defined herein, sparsity refers to the ratio of the number of zero elements to the total number of elements in a set.

In one embodiment, the inference system 104 trains the sparse neural network using a set of training input data and corresponding training inference data to reduce a loss function. For this purpose, the inference system 104 performs training by selecting a subset of weights of the sparse neural network and determines a set of sparse weights for one or more layers. The inference system 104 generates estimated inference data by propagating the training input data through the sparse neural network. The one or more layers generate sparse layer outputs during the training process. The inference system 104 determines a loss function that indicates a difference between training inference data and the estimated inference data, and the set of sparse weights are updated to reduce the loss function.

By taking advantage of sparse representations of weights and layer outputs, the inference system 104 can perform inference and training of the neural network with significantly faster computational speed and less computational resources compared to relatively dense neural networks. Moreover, sparse representation also leads to a significant improvement in robustness and stability with respect to noisy inputs, while maintaining competitive prediction accuracy similar to or above the prediction accuracy of relatively dense neural networks.

### Inference Process of a General Neural Network

FIG. 2 illustrates an example process for performing inference using a neural network, according to an embodiment. The neural network includes a set of layers l=1, 2, . . . , n, each including one or more nodes. For example, in FIG. 2, the neural network includes, among other layers, l−1-th layer 220 including five nodes 226, l-th layer 230 including seven nodes 232, and l−1-th layer 240 including six nodes 242. The neural network illustrated in FIG. 2 may represent a network with a relatively dense set of weights and layer outputs. In addition, while the layers 220, 230 in FIG. 2 are illustrated as intermediate layers that are placed between an input layer that receives the input data and an output layer that generates the inference data, it is appreciated that in other embodiments, any one of the layers 220, 230 may be the input layer or the output layer.

The neural network includes a set of weights W^{l}, l=1, 2, . . . , n associated with each layer. Each non-zero weight may indicate a connection between a node in a current layer and a node in the previous layer. For example, in FIG. 2, the neural network also includes a set of weights W^{l} associated with the l-th layer 230 that represent connections between nodes of the l-th layer 230 and nodes of the previous l−1-th layer 220. The neural network also includes a set of weights W^{l+1} associated with the l+1-th layer 240 that represent connections between nodes of the l+1-th layer 240 and nodes of the previous l-th layer 230. Each node in the layer 230 may be fully connected to nodes of the previous layer, resulting in a large number of connections and a relatively dense set of weights.

During the inference process, the input data 102 is propagated through the neural network starting from the first layer, to generate layer outputs y^{l}, l=1, 2, . . . , n, and eventually, the inference data 106. Specifically, a current layer receives the layer output of nodes at a previous layer, and generate an intermediate output by applying the set of weights for the current layer to the layer output of the previous layer. In particular, a set weights may only be applied to generate an output at connected nodes. The current layer may further generate the layer output by processing the intermediate outputs through an activation function gₗ(⋅) for the layer. In one instance, the activation function may be a rectified linear unit (ReLU) function applied to the intermediate output of each node.

For example, in the neural network shown in FIG. 2, the l-th layer 230 receives the layer output yₗ₋₁ of the five nodes at the previous l−1-th layer 220, and generate an intermediate output ŷₗ by applying the set of weights W^{l} to the layer output yₗ₋₁ of the previous layer. The l-th layer 230 further generates the layer output yₗ by applying the ReLU activation function to the intermediate output ŷₗ of each node. In the example shown in FIG. 2, the sparsity of the l-th layer output yₗ can be determined as 1− 6/7, which is less than 0.14, or 14%. Since the weights and layer outputs are relatively dense, the architecture shown in FIG. 2 may require a significant amount of memory and computational power to generate inference data 106.

### Inference Process of Sparse Neural Network

FIG. 3 illustrates an example process for performing inference using a sparse neural network, according to an embodiment. The sparse neural network shown in FIG. 3 includes, among other layers, l−1-th layer 320 including five nodes 326, l-th layer 330 including seven nodes 332, and l−1-th layer 340 including six nodes 342. In contrast to the neural network shown in FIG. 2, the sparse neural network includes one or more layers associated with a set of sparse weights and/or sparse layer outputs.

The sparse neural network may include a set of sparse weights for one or more layers of the architecture. In one instance, the set of sparse weights may have a sparsity equal to or greater than a first threshold. Specifically, as shown in the example architecture in FIG. 3, the number of connections between nodes of the l-th layer 330 and nodes of the previous l−1-th layer 320, and the number of connections between nodes of the l+1-th layer 340 and nodes of the previous l-th layer 330 may be significantly smaller than the neural network shown in FIG. 2. As a result, of the set of weights W^{l} associated with the l-th layer 330, and the set of weights W^{l+1} associated with the l+1-th layer 340 may have relatively high sparsity.

In one embodiment, the sparsity for a set of weights with respect to the total number of possible connections between the current layer and the previous layer may be equal to or greater than a first threshold. Thus, the sparsity may be determined as the ratio of the number of zero weight values to the total number of possible connections between the current layer and the previous layer, and this ratio may be equal to or greater than a first threshold. For example, in the architecture shown in FIG. 3, the sparsity for the set of weights W^{l} may be determined as the ratio of the number of zero connections to the total number of connections between layer 330 and layer 320. The total number of possible connections is 7 nodes×5 nodes=35 possible connections. In one instance, a set of sparse weights may have a sparsity equal to or greater than 0.30. In other instances, the sparsity may be equal to or greater than 0.70, or may be equal to or greater than 0.90.

In other embodiments, the inference system 104 identifies one or more subsets of possible connections that each represent possible connections between a subset of nodes in the current layer and a subset of nodes in the previous layer. The sparsity for a set of weights with respect to each subset of possible connections may be equal to or greater than a first threshold. Specifically, the sparsity for a subset of possible connections may be determined as the ratio of the number of zero weight values to the number of possible connections in the subset, and the ratio within each of these subsets of connections may be equal to or above the first threshold. For example, in the architecture shown in FIG. 3, the inference system 104 may identify subsets of possible connection between each individual node in the current layer and nodes of the previous layer. For an individual node in the layer 330, the sparsity may be determined as the ratio of the number of zero weight values to the number of possible connections between the individual node in the layer 330 and nodes of the previous layer 320, which is 5 possible connections. In such an example, the sparsity for the set of weights with respect to the subset of possible connections for each node in the layer 330 may be equal to or greater than a first threshold. In one instance, a set of sparse weights for each subset of possible connections may have a sparsity equal to or greater than 0.30. In other instances, the sparsity may be equal to or greater than 0.70, or may be equal to or greater than 0.90.

In one instance, the sparsity of the set of weights for one or more layers of the sparse neural network may be determined such that each individual node in the layer is associated with a fixed number of non-zero weights. For example, in the architecture shown in FIG. 3, every node in the l-th layer 330 may be associated with a fixed number of two connections. Fixing the number of non-zero connections for each node result in a fixed number of matrix multiplications, and may significantly improve the computational speed and efficiency when the sparse neural network is implemented on hardware, such as field-programmable gate arrays (FPGA).

The sparse neural network may also include one or more layers that generate sparse layer outputs. In one embodiment, the sparsity for a layer output may be equal to or greater than a second threshold. The sparse layer output may be generated by selecting a subset of nodes based on the values of their intermediate outputs, and zeroing the remaining subset of nodes in the current layer. In one instance, the selected subset of nodes are nodes having intermediate outputs above a threshold value or a threshold proportion within all nodes of the current layer. Thus, the sparsity for the layer output may be determined as the ratio of the number of nodes with zero values to the total number of nodes in the current layer, and this ratio may be equal to or greater than a second threshold. For example, in the architecture shown in FIG. 3, after generating the set of intermediate outputs, the l-th layer 330 further generates sparse layer outputs yₗ by selecting a subset of nodes having intermediate outputs ŷₗ above a threshold value of 8.0, and zeroing the remaining nodes in the layer 330. In particular, since the first node and the fourth node are associated with intermediate outputs above 8.0, the values for the subset of nodes are selected, and the intermediate outputs for the remaining subset of nodes are zeroed to generate the sparse layer output yₗ. The sparsity of the layer output for the l-th layer 330 may be determined as the ratio of the number of zero values in layer 330 to the number of nodes in layer 330, which is 5 nodes/7 nodes˜0.71. In one instance, a sparse layer output may have a sparsity equal to or greater than 0.80. In other instances, the sparsity may be equal to or greater than 0.90.

In other instances, the inference system 104 identifies subgroups of nodes in the current layer. The sparsity of the layer output within each subgroup of nodes may be equal to or greater than a second threshold by selecting a subset of nodes within each subgroup of nodes. For example, a subset of nodes may be selected within each subgroup that have intermediate outputs above a threshold value or threshold proportion within that subgroup. The sparsity may be determined as the ratio of the number of zero values to the number of nodes in a subgroup, and the sparsity for each of these subgroups may be equal to or greater than a second threshold. For example, in the architecture shown in FIG. 3, the sparsity of the layer output of the l-th layer 330 may be determined with respect to two subgroups nodes in the layer 330, the first subgroup including first to fourth nodes, and the second subgroup including fifth to seventh nodes. As an example, one node with the highest intermediate output may be selected within each subgroup for high sparsity. Thus, the first node within the first subgroup, and the seventh node within the second subgroup are selected, and the values for the remaining subset of nodes may be zeroed to generate the sparse layer output yₗ. The sparsity for a subgroup may be determined as the ratio of the number of zero values to the number of nodes in the subgroup, and the sparsity for each of these subgroups may be equal to or above a second threshold.

In one instance, one or more layers of the sparse neural network may generate sparse layer outputs such that the sparsity of each layer output is associated with a fixed number of non-zero values. For example, a fixed subset of nodes in each layer may be selected based on their intermediate values (e.g., fixed subset of nodes with highest intermediate values), and the remaining subset may be assigned zeros. For example, in in FIG. 3, the l-th layer 330, as well as other layers, may generate a sparse layer output with a fixed number of three non-zero values to improve computational speed and efficiency when the neural network is implemented on hardware. As another example, a fixed subset of nodes may be selected from each subgroup of nodes based on their intermediate values (e.g., fixed subset of nodes within the subgroup with highest intermediate values), such that each subgroup has the same number of non-zero nodes, and the remaining subset in each subgroup may be assigned zeros.

All or a subset of layer of the sparse neural network may generate sparse layer outputs, or have connections associated with a sparse set of weights. For example, the sparse neural network may include a subset of layers that generate sparse layer outputs, and a remaining subset of layers that generate relatively dense layer outputs with a sparsity less than a predetermined threshold or predetermined proportion of nodes, or have connections with a relatively dense set of weights. Moreover, while a given layer may have both sparse layer outputs and sparse weights, a layer may only generate sparse layer outputs, or only have connections with a sparse set of weights.

In FIG. 3, sparse layers and sparse weights have been described with respect to a feed forward architecture, in which nodes of a current layer are connected to nodes of a previous layer that is spatially placed immediately before the current layer. However, in other embodiments, the sparse neural network described in conjunction with FIG. 3 can be applied to any type of neural network including one or more layers of nodes, and include connections between nodes of layers represented by a set of weights.

For example, in recurrent neural networks, including long short-term memory (LSTM) architectures, a current layer of nodes may be connected to a previous layer that represents the same layer of nodes but temporally placed at a previous time. The set of weights representing these connections may have a sparsity equal to or above a first threshold. As another example, a current layer of nodes may also be connected to multiple previous layers, instead of one previous layer. For example, in residual neural networks, a current layer of nodes may be connected to two or more previous layers, such as a first previous layer placed immediately before the layer, and a second previous layer placed before the first previous layer. The collection of weights representing both sets of connections may have a sparsity equal to or above a first threshold, and/or sparse layer outputs may be generated at the current layer of nodes at one or more time steps that have a sparsity equal to or above a second threshold.

FIG. 4 is a flowchart illustrating a method of performing inference using a sparse neural network, according to one embodiment. The inference system 104 receives 412 input data by a trained neural network including a plurality of layers of nodes including a current layer and a previous layer. The inference system 104 generates 416 a layer output of the previous layer based at least on the input data. A set of weights is applied 418 to the layer output of the previous layer that represent connections between nodes of the current layer and nodes of the previous layer. Intermediate outputs for nodes of the current layer are generated 420 by applying the set of weights for the current layer to the layer output of the previous layer. The sparsity of the set of weights may be equal to or above a first threshold. Layer outputs for nodes of the current layer are generated 424 by processing the intermediate outputs. The layer outputs may be generated by selecting intermediate outputs for a subset of nodes in the layer.

The steps shown in FIG. 4 are merely illustrative. One or more of these steps may be used in conjunction, selected or discarded, and/or varied during operation of the inference process. For example, one or more of these steps may be performed in a parallel operation and not in a particular sequence.

### Training Process of a Sparse Neural Network

FIG. 5 illustrates an example process for training a sparse neural network, according to an embodiment. The sparse neural network shown in FIG. 5 includes, among other layers, l−1-th layer 520 including five nodes 526, l-th layer 530 including seven nodes 532, and l−1-th layer 540 including six nodes 542.

The inference system 104 trains the weights of the sparse neural network using a set of training data. The training data includes multiple instances of training input data and training inference data. The training inference data contains known instances of inference data that represent the type of data that the neural network is targeted to predict from the corresponding target input data. For example, the neural network may predict whether an image contains a pedestrian. The training input data may contain multiple images from different scenes, and the corresponding training inference data may contain known labels indicating whether a pedestrian was included in these images.

The inference system 104 trains the sparse neural network by reducing a loss function that indicates a difference between training inference data and estimated inference data that is generated by propagating the corresponding training input data through the architecture. The weights of the sparse neural network may be trained during the training process to learn correlations or relationships between the training input data and the training inference data, such that accurate inference data can be generated for new instances of input data during the inference process.

In one embodiment, the inference system 104 starts the training process by selecting, for each of one or more layers of a neural network, a set of weights that will participate in the training process, such that the sparsity for the selected set of weights is above a first threshold. After the training process, the set of selected weights may be used to generate inference data during the inference process. In one instance, the selected set of weights for a current layer may be randomly sampled from potential connections or subsets of connections between the current layer and a previous layer. In another instance, the selected set of weights for the current layer may be determined based on a rule or criteria by the inference system 104. The remaining set of weights that were not selected are assigned zero values.

In one embodiment, the inference system 104 reduces the loss function by repeatedly iterating a forward pass step and a backpropagation step. During the forward pass step, the inference system 104 generates estimated inference data by propagating a batch of training input data through the sparse neural network. During the backpropagation step, the inference system 104 determines the loss function that indicates a difference between the training inference data and the estimated inference data. The inference system 104 updates the weights of the sparse neural network by backpropagating error terms obtained from the loss function. This process is repeated for multiple iterations with next batches of training data until predetermined criteria is reached. In one instance, to maintain zero values for weights that were not selected in the training process, the inference system 104 zeros the error terms for these weights before each backpropagation step. Alternatively, when these weights have been updated to non-zero values after a backpropagation step, the inference system 104 re-assigns zero values to these weights after the backpropagation step such that zero values are maintained in the sparse neural network.

In FIG. 5, the training process of the sparse neural network has been described with respect to using backpropagation to update the set of weights for reducing the loss function. However, it is appreciated that in other embodiments, any type of optimization algorithm can be used, such as local search methods or other types of global search methods, to reduce the loss function of the architecture.

As discussed in conjunction with FIG. 3, each layer in one or more layers of the sparse neural network may generate sparse layer outputs. Thus, during the forward pass step for an iteration in the training process, a current layer may generate sparse layer outputs based on values of nodes generated by propagating the training data for the iteration through the sparse neural network. For example, a current layer may generate intermediate layer outputs by applying the set of weights for the iteration to layer outputs of the previous layer. The current layer may further generate sparse layer outputs by selecting a subset of nodes having intermediate out puts above a threshold for that iteration. This process may be repeated for subsequent iterations, and different subsets of nodes may be selected at different iterations depending on the training data and the updated values of the weights.

In one embodiment, during the training process, a current layer in the sparse neural network further generates sparse layer outputs for an iteration based on how frequently nodes have been selected during previous training iterations. Specifically, during the training process, a relatively small number of nodes for a given layer may initially dominate, and be repeatedly selected as sparse layer outputs throughout the training process. Having a small number of selected nodes may affect the representation of information in the sparse neural network structure, and thus, may affect the robustness of the neural network.

Thus, in one instance, one or more layers in the sparse neural network generate sparse layer outputs by determining a boosting term for nodes that favor selection of nodes that have not been selected in recent iterations. Specifically, at a training iteration, a current layer may generate sparse layer outputs by selecting a subset of nodes based on their boosting terms that take into account intermediate output of the nodes, as well as how frequently the nodes have been selected as sparse layer outputs in previous training iterations. The inference system 104 may determine boosting terms for layers that generate sparse outputs, perform the forward pass step and the backpropagation step. This process may be repeated for multiple iterations until predetermined criteria is reached.

To determine the boosting term for an iteration, the inference system 104 determines a running average of the duty cycle for a node at the iteration. The duty cycle of the node indicates how frequently the node had been selected as a sparse layer output in one or more previous iterations. In one instance, the running average of the duty cycle dᵢ^{l}(t) for a node i in layer l at iteration t is given by:

$${d}_{i}^{l} ( t ) = ( 1 - α ) \cdot {d}_{i}^{l} ( t - 1 ) + α \cdot [ i ∈ topIndices ] \qquad ( 1 )$$

where dᵢ^{l}(t−1) is the duty cycle of the node at a previous iteration t−1, [i∈topIndices] indicates whether the intermediate output for the node is above the threshold value or the threshold proportion within nodes or subgroups of nodes in layer l, and α is a parameter that balances the relative contribution of the intermediate output for the node and the previous duty cycle for the node to the boosting term.

Based on the running average of the duty cycle, the inference system 104 determines the boosting term for the node that increases as the duty cycle for the node decreases, and decreases as the duty cycle for the node increases. In one instance, the boosting term bᵢ^{l}(t) for node i in layer l at iteration t is given by:

$${b}_{i}^{l} ( t ) = {e}^{β \cdot ( {\hat{a}}^{l} - {d}_{i}^{l} ( t ) )} \qquad ( 2 )$$

where α^{l} is the target duty cycle reflecting the percentage of nodes in the layer that are expected to be selected, and β is a parameter controlling the strength of the boosting. While the relationship between the boosting term and the duty cycle is described as an exponential function in equation (2), embodiments are not limited hereto, and other types of functions can be used.

FIG. 6 illustrates an example exponential relationship between the boosting term and the duty cycle for a node, according to an embodiment. As shown in FIG. 6, the boosting term increases as the duty cycle for the node decreases, and decreases as the duty cycle for the node increases. Since the duty cycle indicates how frequently the node has been selected as sparse layer outputs for previous iterations, selecting the subset of nodes based on boosting term nodes that have not been selected in recent iterations are more likely to be selected, and nodes that have been overly selected are de-emphasized throughout the training process.

After the training process has been completed, the one or more layers of the sparse neural network may generate sparse layer outputs by selecting a subset of nodes based on their boosting terms during the inference process. In such an embodiment, a current layer may generate sparse layer outputs by selecting a subset of nodes based on the boosting term of each node, instead of solely considering the values of the intermediate outputs. For example, a subset of nodes having boosting terms above a threshold value or proportion may be selected within each subgroup of nodes to generate a sparse layer output. In one instance, the boosting term for a node during the inference process is determined using the relationship in equation (2), in which the duty cycle of the node is determined at one or more iterations of the training process, such as the last iteration tₙ of the training process.

FIG. 7 is a flowchart illustrating a method of training a sparse neural network, according to one embodiment. The inference system 104 receives 712 training input data and corresponding training inference data for the training input data for training a neural network including a plurality of layers of nodes including a current layer and a previous layer. A set of weights for the current layer are selected 716 such that a sparsity of the set of weights is equal to or above a first threshold. The selected set of weights represent a subset of possible connections between nodes of the current layer and nodes of a previous layer. For an iteration in one or more training iterations, estimated inference data is generated 720 by propagating the plurality of training input data through the sparse neural network to generate at least an estimated layer output for nodes of the current layers. Error terms are obtained 724 from a loss function to update the set of weights for the current layer. The loss function indicates a difference between the estimated inference data and the training inference data.

In one embodiment, unsupervised learning rules, such as Hebbian learning, that do not explicitly reduce a loss function or do not need an external teacher signal may be used to update the weights for the current layer.

### Sparse Convolutional Neural Network

FIG. 8 illustrates a sparse convolutional neural network (CNN) architecture, according to an embodiment. Compared to a sparse neural network, the sparse CNN architecture described in conjunction with FIG. 8 may additionally include a set of convolutional layers that can be advantageous for processing information in the form of images, videos, sequences of text, and the like. However, the inference process and training process of the sparse CNN architecture may be substantially similar to that described in conjunction with FIGS. 3 through 7.

Specifically, a convolutional layer in the sparse CNN architecture includes a set of nodes arranged as a tensor. The sparse CNN architecture also includes one or more different types of kernels associated with the layer. Each kernel may be associated with a corresponding set of weights. For example, the sparse CNN architecture shown in FIG. 8 includes, among others, l−1-th layer and l-th layer that are convolutional layers. The nodes of the l−1-th layer are arranged as a tensor having width Wₗ₋₁, height Hₗ₋₁, and channel depth Cₗ₋₁. Similarly, the nodes of the l-th layer are arranged as a tensor having width Wₗ, height Hₗ, and channel depth Cₗ. The architecture also includes, among others, a k-th kernel for convolutional layer 830 that is associated with a set of weights Wₖ^{l}.

During the inference process, a convolutional layer generates intermediate outputs in the form of an intermediate tensor by applying the one or more kernels to the layer output of the previous layer. Specifically, each kernel may be sequentially applied to subsets of nodes in the previous layer to generate intermediate outputs for corresponding subsets of nodes in the convolutional layer. Thus, the set of weights for the kernel represent connections between the subsets of nodes in the previous layer and the corresponding subsets of nodes in the convolutional layer. The kernels for a convolutional layer may differ with respect to their dimensionalities, the frequency to which they are applied across the layer output of the previous layer, and the like.

For example, in the architecture shown in FIG. 8, the convolutional layer 830 may apply the set of weights Wₖ^{l} to a subset 824 of nodes in the previous layer to generate intermediate outputs for a corresponding subset 834 of nodes in the convolutional layer. The convolutional layer 830 may apply the same set of weights Wₖ^{l} to the next subset of 828 of nodes in the previous layer to generate a corresponding subset 838 of nodes in the convolution layer 830. This process is repeated for subsequent nodes, and other kernels for the convolutional layer may be applied in a similar manner until intermediate outputs ŷₗ for all nodes in the convolutional layer have been generated as intermediate tensor 832.

In one instance, the sparse CNN architecture may include kernels having a set of sparse weights for one or more convolutional layers. For example, the set of weights for a kernel may have a sparsity equal to or greater than a first threshold. Thus, the sparsity for a kernel may be determined as the ratio of the number of zero weight values in the kernel to the number of total elements in the kernel, and this ratio may be equal to or greater than a first threshold. During the training process, the inference system 104 may select, for each of one or more kernels, the set of weights such that the sparsity for the selected set of weights is above a first threshold.

The convolutional layer may generate sparse layer outputs in the form of a sparse tensor by selecting a subset of nodes in the intermediate tensor, and zeroing the remaining nodes in the intermediate tensor. For example, a subset of nodes may be selected within the intermediate tensor that have nodes with intermediate outputs or boosting terms above a threshold value or a threshold proportion within the intermediate tensor. For example, in the architecture shown in FIG. 8, the convolutional layer 830 further generates the sparse tensor 836 by selecting a subset of nodes in the intermediate tensor 832 having intermediate outputs ŷₗ or boosting terms above a threshold value, as shown by the nodes with striped patterns, and zeroing the remaining subset of nodes.

FIGS. 9A and 9B illustrate generating sparse tensors in a convolutional layer, according to an embodiment. In other embodiments, the sparse tensor may be generated by selecting the subset of nodes within each different subgroups of nodes in the intermediate tensor. In one instance, the subgroups of nodes are volumes of nodes within the intermediate tensor that are associated with a smaller dimensionality than the dimensionality of the intermediate tensor. For example, in the convolutional layer shown in FIG. 9A, a subset of two nodes are selected within each rectangular volume of nodes. As shown by the nodes with striped patterns, two nodes are selected from each example rectangular volume 934 and 938 that have intermediate outputs or boosting terms above a threshold value or threshold proportion.

In another instance, the subgroups of nodes are nodes at different channel depths within the intermediate tensor. For example, in the convolutional layer shown in FIG. 9B, a subset of five nodes are selected within each channel depth of nodes. As shown by the nodes with striped patterns, five nodes are selected from nodes at example channel depth 964 that have intermediate outputs above a threshold value or threshold proportion, and another five nodes may be selected from nodes at subsequent channel depths of the tensor, and so on.

In another instance, one or more layers of the sparse CNN architecture may generate sparse tensors such that the sparsity of each tensor is associated with a fixed number of non-zero values. For example, the convolutional layer may generate a sparse tensor with a fixed number of non-zero values across the channel depth for nodes at a given width and height.

In one embodiment, when the sparse CNN is trained using the boosting term, the inference system 104 determines the boosting term based on channels of the sparse CNN, rather than individual units of a current layer. In one instance, the running average of the duty cycle d_{c}^{l}(t) for a channel c in layer l at iteration t is given by:

$${d}_{c}^{l} ( t ) = ( 1 - α ) \cdot {d}_{c}^{l} ( t - 1 ) + α \cdot \frac{{‖ {y}_{c}^{l} ( t ) ‖}_{0}}{{w}^{l} \cdot {h}^{l}} \qquad ( 3 )$$

where d_{c}^{l}(t−1) is the duty cycle of the channel at a previous iteration t−1, ∥y_{c}^{l}(t)∥₀ indicates the number of selected nodes within the channel, w^{l} indicates the width of the tensor and hl indicates the height of the tensor for layer l, and α is a parameter that balances the relative contribution of the intermediate output for the channel and the previous duty cycle for the channel to the boosting term. The boosting term b_{c}^{l}(t) for channel c in layer l at iteration t is given by:

$${b}_{c}^{l} ( t ) = {e}^{β \cdot ( {\hat{a}}^{l} - {d}_{c}^{l} ( t ) )} \qquad ( 4 )$$

where a^{l} is the target duty cycle given by k/C^{l} where C^{l} is the number of channels in layer l, and β is a parameter controlling the strength of the boosting.

### Experimental Results for Dense and Sparse Neural Networks

FIG. 10 illustrates sparsity characteristics for weights and layer outputs of a set of example neural networks. FIG. 11 illustrates experimental performance metrics of the example neural networks. Specifically, each example architecture includes three layers, L1, L2, and L3. The column “L1 Nodes” indicates the number of nodes in the first layer L1, the column “L1 Sparsity” indicates the sparsity of the layer outputs at the first layer L1, the column “L1 Weight Sparsity” indicates the sparsity of a set of weights representing connections between the first layer L1 and the input layer, the column “L2 Nodes” indicates the number of nodes in the second layer L2, the column “L2 Output Sparsity” indicates the sparsity of the layer outputs at the second layer L2, the column “L2 Weight Sparsity” indicates the sparsity of a set of weights representing connections between the second layer L2 and the first layer L1, the column “L3 Nodes” indicates the number of nodes in the third layer L3, the column “L3 Output Sparsity” indicates the sparsity of the layer outputs at the third layer L3, and the column “L3 Weight Sparsity” indicates the sparsity of the set of weights representing connections between the third layer L3 and the second layer L2.

In Table 2, the column “Test Score” indicates the accuracy of the inference data of an example neural network on test data, the column “Noise Score” indicates the total number of correctly classified inputs for all test inputs that have noise added to it, the column “Noise Accuracy” indicates the average accuracy of the inference data of an example neural network in which additive noise is added to the test data, the column “Non-zero Parameters” indicates the number of non-zero weights at nodes in the example neural network.

As indicated in Table 2, the example neural network “denseCNN2” having the highest number of non-zero parameters at 1,717,140, is associated with a noise score and noise accuracy that is significantly lower than that of the remaining subset of sparse neural networks. This indicates that sparse neural networks have improved robustness to noise compared to relative dense architectures, while maintaining similar or greater accuracy than dense architectures.

FIG. 12 is a block diagram of a computing device 1200 for implementing inference systems according to embodiments. The computing device 1200 may include, among other components, a processor 1202, a memory 1206, an input interface 1210, an output interface 1214, a network interface 1218, and a bus 1220 connecting these components. The processor 1202 retrieves and executes commands stored in memory 1206. The memory 1206 store software components including, for example, operating systems and modules for instantiating and executing nodes as described herein. The input interface 1210 receives data from external sources such as sensor data or action information. The output interface 1214 is a component for providing the result of computation in various forms (e.g., image or audio signals). The network interface 1218 enables the computing device 1200 to communicate with other computing devices by a network. When multiple nodes or components of a single node is embodied in multiple computing devices, information associated with temporal sequencing, spatial pooling and management of nodes may be communicated between computing devices via the network interface 1218.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

1. (canceled)

2. A method, comprising:
receiving input data by a network including a plurality of layers including a first layer and a second layer subsequent to the first layer;
generating an intermediate output of the first layer by applying, to the input data, a set of weights that represent connections from nodes of the first layer;
generating a layer output of the first layer by increasing sparsity of the intermediate output; and
feeding a version of the layer output of the first layer to nodes of the second node.

3. The method of claim 2, wherein the generating of the layer output comprises:
selecting intermediate outputs having values above a threshold or within a percentage of highest values;
setting values of the selected intermediate outputs as values of corresponding nodes of the first layer; and
setting, to zero, values of nodes of the first layer corresponding to non-selected intermediate outputs.

4. The method of claim 3, further comprising determining a boosting term for each node of the first layer indicating how frequently the node was selected during previous iterations, wherein the intermediate outputs are selected based further on the boosting term.

5. The method of claim 4, wherein the boosting term increases as a duty cycle of each node increases and decreases as the duty cycle of each node decreases.

6. The method of claim 2, further comprising backpropagating error terms to update the set of weights, wherein the error terms are derived from the layer output and the input data.

7. The method of claim 2, wherein the network is a convolutional neural network.

8. The method of claim 2, wherein the network is implemented using field-programmable gate arrays.

9. The method of claim 2, further comprising:
generating the version of the layer output by processing the layer output of the first layer.

10. The method of claim 9, wherein the processing of the layer output of the first layer comprises:
applying, to the layer output of the first layer, another set of weights to generate the version of the layer output.

11. A non-transitory computer readable storage medium storing instructions thereon, the instructions when executed by one or more processors cause the one or more processors to:
receive input data by a network including a plurality of layers including a first layer and a second layer subsequent to the first layer;
generate an intermediate output of the first layer by applying, to the input data, a set of weights that represent connections from nodes of the first layer;
generate a layer output of the first layer by increasing sparsity of the intermediate output; and
feed a version of the layer output of the first layer to nodes of the second node.

12. The non-transitory computer readable storage medium of claim 11, wherein the instructions to generate the layer output comprises instructions to:
select intermediate outputs having values above a value or within a percentage of highest values;
set values of the selected intermediate outputs as values of corresponding nodes of the first layer; and
set, to zero, values of nodes of the first layer corresponding to non-selected intermediate outputs.

13. The non-transitory computer readable storage medium of claim 12, wherein the instructions further cause the one or more processors to:
determine a boosting term for each node of the first layer indicating how frequently the node was selected during previous iterations, wherein the intermediate outputs are selected based further on the boosting term.

14. The non-transitory computer readable storage medium of claim 13, wherein the boosting term increases as a duty cycle of each node increases and decreases as the duty cycle of each node decreases.

15. The non-transitory computer readable storage medium of claim 11, wherein the instructions further cause the one or more processors to:
backpropagate error terms to update the set of weights, wherein the error terms are derived from the layer output and the input data.

16. The non-transitory computer readable storage medium of claim 11, wherein the network is a convolutional neural network.

17. The non-transitory computer readable storage medium of claim 11, wherein the instructions further cause the one or more processors to:
generate the version of the layer output by processing the layer output of the first layer.

18. The non-transitory computer readable storage medium of claim 17, wherein the instructions to process the layer output of the first layer comprises instructions to:
apply, to the layer output of the first layer, another set of weights to generate the version of the layer output.

19. A non-transitory storage medium storing a digital representation of a neural network, the neural network generated by:
receiving input data by a network including a plurality of layers including a first layer and a second layer subsequent to the first layer;
generating an intermediate output of the first layer by applying, to the input data, a set of weights that represent connections from nodes of the first layer;
generating a layer output of the first layer by increasing sparsity of the intermediate output; and
feeding a version of the layer output of the first layer to nodes of the second layer.

20. A non-transitory storage medium of claim 19, wherein the layer output is generated by:
selecting intermediate outputs having values above a threshold or within a percentage of highest values;
setting values of the selected intermediate outputs as values of corresponding nodes of the first layer; and
setting, to zero, values of nodes of the first layer corresponding to non-selected intermediate outputs.
